(19) United States
(12) Patent Application Publication
(10) Pub. No.: US 2025/0165575 A1
(43) Pub. Date: May 22, 2025

(54) SYSTEM FOR SYSTEM FOR CREATING, STORING, AND PORTABLY UTILIZING VERIFIED DIGITAL IDENTITIES

(71) Applicant: Scientia Potentia Est II, LLC, Charleston, SC (US)

(72) Inventors: Jeremy Blackburn, Charleston, SC (US); Justin Southward, Fort Meyers, FL (US); Timothy Hines, Frisco, TX (US); Matthew Koepp, Frisco, TX (US)

(73) Assignee: Scientia Potentia Est II, LLC, Charleston, SC (US)

(21) Appl. No.: 19/032,916

(22) Filed: Jan. 21, 2025

Related U.S. Application Data
(63) Continuation-in-part of application No. 17/697,839, filed on Mar. 17, 2022, now abandoned.
Application No. 17/697,839 is a continuation-in-part of application No. 17/686,502, filed on Mar. 4, 2022, now Pat. No. 11,610,202.
Application No. 17/686,502 is a continuation-in-part of application No. 17/566,957, filed on Dec. 31, 2021.
Application No. 17/566,957 is a continuation-in-part of application No. 17/561,827, filed on Dec. 24, 2021, now Pat. No. 11,574,319.
Application No. 17/561,827 is a continuation-in-part of application No. 17/531,746, filed on Nov. 20, 2021, now Pat. No. 11,482,325.
Application No. 17/531,746 is a continuation-in-part of application No. 17/531,598, filed on Nov. 19, 2021, now abandoned.
Application No. 17/531,598 is a continuation-in-part of application No. 17/344,043, filed on Jun. 10, 2021, now abandoned.
Application No. 17/344,043 is a continuation-in-part of application No. 17/230,911, filed on Apr. 14, 2021, now Pat. No. 11,288,761.
Application No. 17/230,911 is a continuation-in-part of application No. 17/176,056, filed on Feb. 15, 2021, now Pat. No. 11,288,308.
Application No. 17/176,056 is a continuation-in-part of application No. 17/128,084, filed on Dec. 19, 2020, now Pat. No. 11,521,157.
Application No. 17/128,084 is a continuation-in-part of application No. 16/997,840, filed on Aug. 19, 2020, now Pat. No. 11,449,949.
Application No. 16/997,840 is a continuation-in-part of application No. 16/994,585, filed on Aug. 15, 2020, now Pat. No. 11,232,652.
Application No. 16/994,585 is a continuation-in-part of application No. 16/991,916, filed on Aug. 12, 2020, now Pat. No. 11,216,823.
Application No. 16/991,916 is a continuation-in-part of application No. 16/876,080, filed on May 17, 2020, now Pat. No. 11,423,360.
Application No. 16/876,080 is a continuation-in-part of application No. 16/810,782, filed on Mar. 5, 2020, now Pat. No. 11,216,781.
Application No. 16/810,782 is a continuation-in-part of application No. 16/510,634, filed on Jul. 12, 2019, now Pat. No. 10,713,737.
Application No. 16/510,634 is a continuation-in-part of application No. 16/452,076, filed on Jun. 25, 2019, now abandoned.
Application No. 16/810,782 is a continuation-in-part of application No. 16/510,642, filed on Jul. 12, 2019, now Pat. No. 11,216,772.
Application No. 16/510,642 is a continuation-in-part of application No. 16/452,076, filed on Jun. 25, 2019, now abandoned.

(51) Int. Cl. G06F 21/32; G06Q 20/40

(52) U.S. Cl. CPC G06F 21/32; G06Q 20/40145

(57) ABSTRACT

The present system can include the ability to create and store a unique digital identity using biometric authentication, immutable storage, and self-sovereign identity management. An identity capture device can be adapted to receive biometric information from the identity capture device, create a digital representation, store the digital representation on a portable media. The digital representation can be compared with captured information to determine authenticity.

### RELATED APPLICATIONS

This application claims benefit of provisional from U.S. patent Ser. No. 18/652,588 filed on May 1, 2024; which claims benefit of provisional from U.S. patent 63/463,481 filed on May 2, 2023; which claims benefit of provisional from U.S. patent 63/499,659 filed on May 2, 2023; which claims benefit of provisional from U.S. patent 63/499,728 filed on May 3, 2023; which claims benefit of provisional from U.S. patent 63/622,366 filed on Jan. 18, 2024; which claims benefit of provisional from U.S. patent 63/499,728 filed on May 3, 2023; which claims benefit of provisional from U.S. patent 63/499,659 filed on May 2, 2023; which claims benefit of provisional from U.S. patent 63/463,481 filed on May 2, 2023; which is a continuation in part of Ser. No. 17/697,839 filed on Mar. 17, 2022; which is a continuation in part of Ser. No. 17/686,502 filed on Mar. 4, 2022; which is a continuation in part of Ser. No. 17/566,957 filed on Dec. 31, 2021; which is a continuation in part of Ser. No. 17/618,27 filed on Dec. 24, 2021; which is a continuation in part of Ser. No. 17/531,746 filed on Nov. 20, 2021; which is a continuation in part of Ser. No. 17/531,598 filed on Nov. 19, 2021; which is a continuation in part of Ser. No. 17/344,043 filed on Jun. 10, 2021; which is a continuation in part of Ser. No. 17/230,911 filed on Apr. 14, 2021; which is a continuation in part of Ser. No. 17/176,056 filed on Feb. 15, 2021; which is a continuation in part of Ser. No. 17/128,084 filed on Dec. 19, 2020; which is a continuation in part of Ser. No. 16/997,840 filed on Aug. 19, 2020; which is a continuation in part of Ser. No. 16/994,585 filed on Aug. 15, 2020; which is a continuation in part of Ser. No. 16/991,916 filed on Aug. 12, 2020; which is a continuation in part of Ser. No. 16/876,080 filed on May 17, 2020; which is a continuation in part of Ser. No. 16/810,782 filed on Mar. 5, 2020; which is a continuation in part of Ser. No. 16/510,634 filed on Apr. 12, 2019; which is a continuation in part of Ser. No. 16/452,076 filed on Jun. 25, 2019; which is a continuation in part of Ser. No. 16/510,642 filed on Jul. 12, 2019; which is a continuation in part of Ser. No. 16/452,076 filed on Jun. 26, 2019; all of which are incorporated by reference.

### BACKGROUND

### 1) Field of the System

A system for creating and storing verified portable digital identities using immutable records verified with third party system that can include verification with one or more events and activities including governmental identification issuance, storage, and verification systems wherein the digital identities can be authenticated.

### 2) Background

In many industries, confirming an individual's identity with a high degree of confidence is critical. Trust in digital identity verification is foundational for commerce, banking, government services, employment, healthcare, and online interactions. Traditionally, identity verification has relied on government-issued documents such as driver's licenses, passports, and Social Security Numbers (SSNs). While these forms of identification are widely used, they expose personal information and are susceptible to fraud, theft, and forgery. One of the main drawbacks of traditional identity verification is the potential for personal data exposure. State or federally issued identification cards contain sensitive personal details such as name, address, birth date, and biometric images. When presented, these documents reveal more information than necessary, increasing the risk of identity theft, financial fraud, and unauthorized tracking.

As fraudulent techniques have evolved, criminals have become proficient at creating fake identifications through “image substitution” techniques, where they modify passports or driver's license photos to impersonate legitimate individuals. This allows unauthorized access to financial services, government benefits, medical treatment, and even legal impersonation. The risks associated with such identity fraud include financial losses, fraudulent credit accounts, tax return theft, and reputational damage, often requiring victims to go through extensive processes to recover their identity.

Digital identities have been introduced to address some of these challenges. However, existing digital identity systems remain dependent on centralized databases, creating vulnerabilities to data breaches and unauthorized access. These systems often rely on remote verification against state-controlled databases, which store extensive personal records, including criminal history, financial data, and social service interactions. The security of these databases is reliant on legal protections rather than technological safeguards, and historical evidence has shown that these protections are frequently inadequate.

In some cases, improper access to digital identity databases has been reported, where individuals, including government employees, have abused their access rights to retrieve personal data for unauthorized reasons. Reports indicate that digital identity records have been accessed for personal curiosity, stalking, or legal disputes, further exposing the inherent risks of centralized identity storage.

Another shortcoming of existing digital identity verification methods is their reliance on scanning and transmitting sensitive identity documents over unsecured networks. Many online services require users to upload scans of their identification cards for verification, creating significant vulnerabilities. Hackers can intercept these uploads through snooping attacks, leading to data leaks and unauthorized use of personal credentials.

Further, digital identity systems often depend on traditional methods such as government APIs, credit bureau records, and mobile phone-based verification, all of which have limitations in ensuring real-time identity validation without exposing personal data. Inadequate verification processes, combined with weaknesses in liveness detection and anti-spoofing mechanisms, make current systems susceptible to deepfake attacks and synthetic identity fraud.

Blockchain and decentralized identity models have emerged as alternatives, but they have struggled with mass adoption due to a lack of interoperability, privacy concerns, and reliance on cryptographic credentials that do not inherently verify the authenticity of an individual. Additionally, many blockchain-based identity solutions still require online connectivity and access to external databases for real-time validation, reducing their effectiveness in privacy-focused environments.

The present invention improves upon prior art by introducing a system that: provides an immutable, decentralized self-sovereign identity system that minimizes reliance on centralized databases; enables privacy-preserving authentication by allowing selective disclosure of identity attributes without exposing personally identifiable information (PII); uses biometric authentication combined with real-time fraud detection, liveness verification, and cryptographic validation to ensure authenticity; supports offline and near-field verification through secure portable identity storage, reducing the need for online database queries; and integrates with regulatory and compliance frameworks while maintaining user control over identity access and disclosure.

Therefore, it is an object of the present invention to address these issues and provide a system with enhanced identity security, that mitigates fraud risks, and enables privacy-centric authentication across multiple industries and digital platforms.

### SUMMARY OF THE INVENTION

A digital system for management of a digital identity associated with an individual comprising: a capture device wherein the capture device is adapted to capture biometric information, alphanumeric information, graphical information and any combination; a verification system in communications with the capture device; and wherein the verification system is adapted to create a digital representation of the individual according to the biometric information, receive a digital envoy creation request, transmit the digital representation request to an authority system; create a digital envoy uniquely associated with the digital representation according to receiving creation authorization from the authority system, and store the digital envoy on a portable media.

### BRIEF DESCRIPTION OF THE DRAWINGS

FIG. 1A is a diagram of aspects of the system showing hardware and

processes.

FIG. 1B is a diagram of aspects of the system showing hardware and their relation.

FIG. 2 is a diagram of aspects of the system showing process flow.

FIG. 3 is a diagram of aspects of the system showing data flow.

FIG. 4 is a diagram of aspects of the system and storage and communications.

FIG. 5 is a diagram of aspects of the system showing data representing physical objects.

FIG. 6 is a schematic of aspects of the system showing hardware.

FIG. 7 is a flowchart of aspects of the system showing hardware, process, and data flow.

FIG. 8 flowchart of aspects of the system showing hardware, process, and data flow.

FIG. 9 is a schematic of aspects of the system and one embodiment of the process.

FIG. 10 is a schematic of aspects of the system and one embodiment of the process.

FIG. 11A is a flowchart of aspects of the system showing process.

FIG. 11B is a flowchart of aspects of the system showing process.

FIG. 12A is a flowchart of aspects of the system showing process.

FIG. 12B is a flowchart of aspects of the system showing process.

FIG. 13 is a flowchart of aspects of the system showing process.

FIG. 14 is a flowchart of aspects of the system showing process.

FIG. 15A is a flowchart of aspects of the system showing process.

FIG. 15B is a flowchart of aspects of the system showing process.

FIG. 15C is a flowchart of aspects of the system showing process.

### DETAILED DESCRIPTION

This system includes the ability to securely and properly verify an identity using a digital representation without exposing personal information is needed and preventing “image substitution” for fakes is needed. This system can provide improved functionality to computerized systems by, among other things, allowing the verification and authentication of a digital identity without the exposure of personal information and in on embodiment, without the need for accessing remote systems.

For example, the system can provide for the verification and authentication of a digital identity without the need to access a governmental verification system each time the identity needs to be verified. The system can improve computerized systems by immutable storing tokens that are associated with verified identities allowing the token to serve as part of the verified and authentic identification process. The token can be digitally stored on a portable media such as an identification card or other card. The token can be a digital representation, such as a hash, and can be stored on a digital media that is included on the identification card.

The system can allow the user to capture biometric information of the presenting individual, which can then compare to a locally stored digital representation and if the captured image and the digital information match, the identity can be verified. The card can include storage media such as a chip or magnetic media. This media can include a digital representation of a verified digital identification. The digital information on the card can be transferred to a vendor using magnetic stripe reader, chip reader or near field communications (NFC). The digital representation of the presenting individual is read from the card and compared with the captured information of the presents. For example, the storage media can include a digital hash of an image of the presenter allowing the digital representation to be stored in a record of a fixed length. A computerized system can capture the facial image of the presenter, calculate the hash from the captured image and compare that to the digital representation. If the two match, the presenter is verified and authentic.

To create the digital representation, an identity recording system can be adapted to transmit to a verification system in communication with the identity recording system, receive a verification response from the verification system and create the digital identity record according to verification response. The results can be stored on the card.

The present invention provides a comprehensive system for digital identity verification and authentication using self-sovereign principles, biometric verification, and immutable records. Unlike traditional centralized identity systems that expose users to fraud and data breaches, this system ensures secure and privacy-preserving identity management. Key aspects of the invention include: A self-sovereign digital identity framework that allows individuals to control and manage their identity securely; Biometric-based authentication for password less and fraud-resistant identity verification; Immutable storage mechanisms (blockchain or distributed ledger technology) ensuring tamper-proof recordkeeping; Portable digital identity envoy, allowing identity validation across multiple platforms without exposing personal data; Anonymous attribute-based verification, supporting applications such as age verification and regulatory compliance without disclosing full identity details; Multi-factor verification, combining government-issued records, device metadata, geolocation, data record surety and grading or levels, and biometric data for high-confidence authentication.

This system enables secure transactions, online verification, and compliance with industry regulations while preserving user privacy. The self-sovereign model ensures that identities are not dependent on a single central authority but instead leverage decentralized, user-controlled verification methods.

### INDUSTRIAL APPLICABILITY

The invention is applicable across various industries where secure, portable, and privacy-focused digital identity verification is required, including: Financial Services & Banking; Prevents fraud in credit card transactions by requiring biometric verification; Supports KYC (Know Your Customer) and AML (Anti-Money Laundering) compliance; E-Commerce & Online Services; Provides seamless digital identity authentication for age-restricted content; Eliminates the need for passwords while ensuring secure transactions; Government & Regulatory Compliance; Enables secure online voting and digital driver's licenses.

Through identity attributes immutably recorded from the source of truth with transparent provenance ensures compliance with privacy laws such as GDPR, CCPA, and AML regulations.

Concerning healthcare & medical identity verification, this system can provide for secures patient records with biometric-based access control and allows controlled sharing of medical information without exposing unnecessary data. Concerning enterprise and workforce verification, the system can enable secure employee identity verification for onboarding and access control and reduces exposure to phishing and identity fraud in corporate environments.

This system provides scalability, interoperability, and robust security, ensuring it meets the evolving needs of governments, businesses, and individuals in digital identity management.

### LEGAL AND REGULATORY COMPLIANCE

The system is designed to comply with existing and emerging legal standards, including: General Data Protection Regulation (GDPR), ensures that personal identity data remains secure and user-controlled; California Consumer Privacy Act (CCPA), supports data privacy and opt-in authentication controls; Know Your Customer (KYC); Anti-Money Laundering (AML) Regulations, enables financial institutions to meet regulatory requirements without exposing user data; Children's Online Privacy Protection Act (COPPA), allows secure age verification for child safety online; Decentralized Identity Standards (W3C DID, Verifiable Credentials), aligns with global digital identity frameworks to ensure interoperability.

By implementing privacy-first identity validation and compliance-driven frameworks, this invention provides a future-proof, legally compliant digital identity solution.

The present system provides for the creation, storage, and use of digital identities by pairing the digital representation of an individual with the actual physical individual and storing the digital representation on a portable media such as an identification card or portable device. The present invention relates to a system and method for creating, storing, managing, and validating digital identities in a secure, portable, and privacy-preserving manner. The system leverages immutable storage, biometric verification, self-sovereign identity management, and decentralized authentication to provide a solution that mitigates identity fraud, enhances user privacy, and facilitates anonymous validation of identity attributes. The system can include a computer device, a capture device and readable computer instructions that can provide a computer system that can be in communication with one or more databases, an immutable storage system, third party systems, verifications system and any combination thereof. Various systems can be included that can be in a single information system configuration or can be multiple information systems in communications with each other. For example, a first capture device can be a specific computer device designed to capture biometric data, location data, date, time and other input. The system can include a camera, fingerprint reader, DNA reader and other biometric capture device(s). The system can include a camera to capture facial, documents, and physical identification information.

An identity recording system can be used to create digital identification which can include a digital identity record and digital envoy. A digital identity record can be a cryptographic reference of the record, used as a digital functional equivalent of the individual identity, and stored immutably. The invention enables the creation of a digital identity that is validated against government-issued sources of truth such as birth certificates, driver's licenses, passports, Social Security records, and tax documents. These records are often stored in centralized databases and have traditionally been susceptible to fraud and forgery. Within a decentralized framework, the system ensures the trustworthiness of government-issued sources through cryptographic attestations, decentralized validation protocols, and multi-party verification mechanisms, ensuring that once validated, identity attributes remain immutable, resistant to forgery, and traceable to authoritative origins. The system also employs multi-factor biometric validation, ensuring that even if one authentication method is compromised, additional cryptographic and biometric factors reinforce identity assurance. Furthermore this record can be used to reference the individual, and their corresponding certainty level. The record can be a hash of identifying information such as biometrics.

The identity recording system can be used for a variety of purposes, including verifying digital identities, verifying physical objects and their association with digital representations, validating events and activities, and managing tokens to facilitate authentication. The system ensures that digital representations are properly associated with physical individuals and objects. The system provides multi-factor identity verification using biometric data (e.g., facial recognition, vascular mapping, cardiac rhythm, DNA), device metadata, temporal data, geolocation, and source-of-truth validation to ensure that the digital identity is authentic, immutable, and securely stored in a self-sovereign digital wallet. One of the key enhancements over prior art is the ability to mitigate security risks associated with biometric authentication, including replay attacks, synthetic identity fraud, and deepfake impersonation attempts. The system employs continuous liveness detection algorithms, multi-source biometric comparison, behavioral analysis, and cryptographic validation to ensure that biometric inputs are genuinely captured from a live user and not replayed from pre-recorded data.

Once verified, the digital identity is hashed and stored on an immutable ledger or similar tamper-proof storage medium. The individual controls access to their identity through biometric authentication rather than traditional passwords, mitigating the risk of credential theft and unauthorized access. The identity can be used across multiple platforms to validate attributes such as age, residency, or eligibility for regulated transactions without disclosing personally identifiable information (PII). This approach balances the need for strong identity verification with privacy protection

Additionally, the system allows for anonymous identity validation via a digital envoy. The digital envoy serves as a portable authentication token that can confirm identity attributes, such as age or residency, without exposing full identity details. The envoy is linked to an immutable record that captures the provenance of each attribute, ensuring that validation processes remain transparent, auditable, and verifiable by regulatory entities when necessary. The system further enables ongoing identity validation events, reinforcing the surety level of the digital identity over time.

The identity recording system and the verification system can be centralized, decentralized, immutable, distributed, local, remote, shared, private, virtual and any combination. The identity recording system can be immutable and persistent so that the information stored on the identity recording system, once storage, cannot be changed. The identity recording system can include a plurality of computer systems where certain data can be copied onto each computer system. Examples of data storage platforms that can be used by the transaction systems include hard drives, solid state drives, tapes, and cloud storage systems. The immutable data storage system can use quantum, blockchain, crypto-shredding, WORM, append only, distributed ledger technology, immutable cloud storage, immutable record retention (e.g., Oracle Cloud Infrastructure Object Storage, Quantum Ledger Database), any system that makes it improbable, or not known to be possible, to permanently record information such as alteration of the information is not possible without detection and any combination thereof). In one embodiment the immutability is accomplished by the data storage system only allowing records to be appended to the storage media without the ability to modify the record once written. One such system includes blockchain.

The Digital Identity created through this system can be used for any digital medium that is configured to accept the self-sovereign envoy. This means that a single verified identity can be ported and utilized wherever digital identity validation is required, ensuring seamless and secure authentication across multiple platforms. The invention provides a universal, portable identity solution that eliminates the need for multiple identity credentials and reduces the risk of data breaches associated with traditional identity storage methods.

This invention addresses critical challenges in identity management, online privacy, and digital fraud prevention, making it applicable to use cases such as financial transactions, government authentication, regulated digital content access, and fraud-resistant e-commerce interactions.

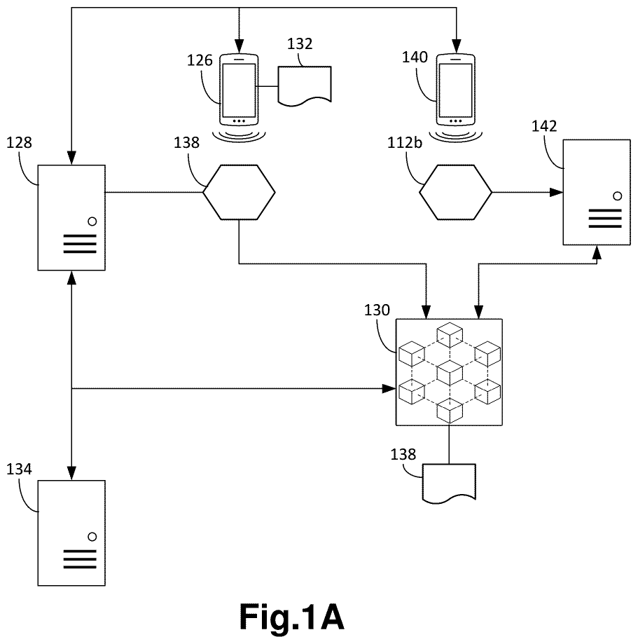

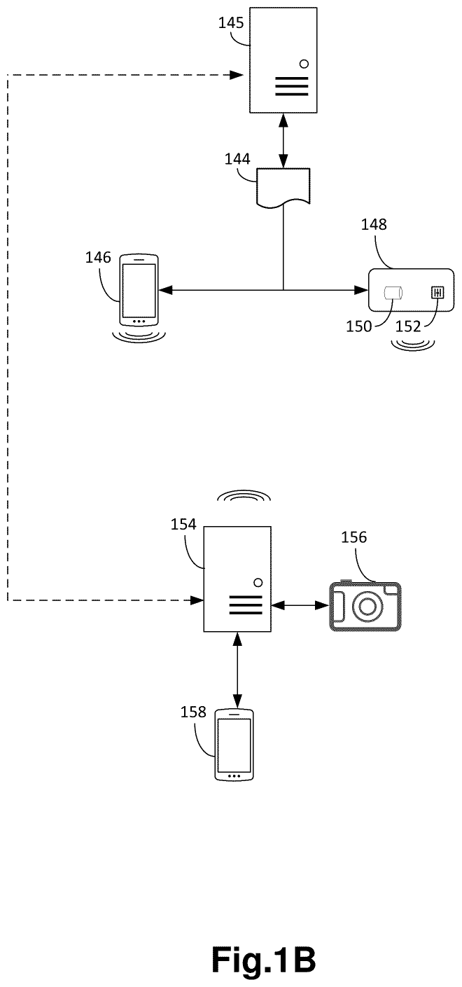

Referring to FIG. 1A, the creation of a digital identity is shown. The capture device 126 can be in communications with an identity recording system 128 through electronic communication such as a secured connection, wired or wireless. The identity recording system can be in communication with an immutable storage system 130. The identity recording system 128 can be in communication with a verification system 134. The verification system can be a closed system that includes previously authenticated and verification identity information. For example, the verification can be a governmental verification system such as maintained by the local, state, regional, or federal government. For example, one verification system includes driver's license information and verification system. This system creates an identity record of an individual that can include a multistep process. First, the individual much complete a form that can include personal information such as name, date of birth, gender, place of birth, social security number, email, contact phone number, mailing address and prior names that may have been used. This form with the personal information is then presented to a governmental facility. The form is submitted to a verifying person along with other documents with personal information such as birth certificate, passports, consular report of birth abroad, certificate of citizenship and the like. Proof of identification can also be provided that can include driver's license, prior or current passports, military identifications, federal, state or city government employee identification, certification of naturalization and the like. A facial image can be taken at the governmental facility and associated with the application and subsequent driver's license. This process can be used by the verification system as well.

The identity record can be stored on portable media and can be a digital representation of the individual. The identity recording system can capture biometric information of the user as well as an identification document and can pass this information to the verification system. The information can be passed encrypted or otherwise over a controlled network. The information can be passed through an application programming interface to the verification system. The verification system can return a VALID or INVALID, VERIFIED or NOT VERIFIED or other like response representing that the biometric information and identification document matches a record on the validation system. If so, the identity recording system can create a digital identity record 136 that is associated with the individual to provide for a digital identification. The digital identity record can be stored on the immutable storage system can be in a digital wallet of the user. A digital envoy 138 can be created and adapted to retrieve the digital identity record from the immutable storage. The digital envoy can be a code, documents, object, or other item which allows the digital identity record to be retrieved. In one embodiment, the digital envoy can be an alpha-numeric, graphical, image, bar code, digital quick response code or other indicia that can be displayed on a user's device such as a mobile phone. The digital envoy can also be a RFID that can be in a card format, fob, or other portable footprint that can be presented for authentication.

Referring to FIG. 1B, in one embodiment, the portable footprint can contain the digital representation 144 of the presenting individual. When an account is created, the verification information described herein is created verified digital representation is created and can be stored on a server 145. The digital representation can also be stored on a portable device such as a smart phone 146 or identification card 148. The card can include a storage media 150 of EMV chip 152 that can include the digital information of the presenter. In one embodiment, the digital information cannot be changed (e.g., immutably stored) so that it is tied to an account of an individual or the individual him or herself.

In the event that the portable media is a card, the card can include near field communications for transmitting the digital information to a transaction system 154 which can include authentication functionality. When the card is presented, a capture device 156 in communication with the transaction system 154 can capture the presenter's information. For example, capture device 156 can capture the facial image (e.g., selfie) of the presenting individual. The system can retrieve the digital representation from the portable device (e.g., card) and compare the captured image with the digital representation. If they match, the presenter's identity is authentic. In one embodiment, the card is presented (or other transaction information such as account number and the like) the transactional system can retrieve the digital information from a server such as 145, retrieve the local information (e.g., selfie) from the transactional server 154 and compare the two. If they match, the presenter's individual identity is verified and authentic. In this case the portable media does not need to store the digital information, but need only to point to the location of the digital information that represents the individual.

In one embodiment, the transactional system may not have the ability to capture the presenter's information (e.g., may not have a camera). In this case, the transactional system can send a link or message to the presenter's device such as a presenter's mobile device 158. In one embodiment, the transactional system can send a text (e.g., SMS), or in app, message to the presenter's device. The message can be used to instruct the presenter's device to capture information about the presenter and send the information to the transactional system. The transactional system can compare this information to the digital envoy record information to determine if there is a match.

Therefore, the transactional server need not have a capture device.

In one example, the presenter initially opens a credit account, such as applying for a credit card. In the process, the presenter presenter's facial image is captured, verified, and stored when the account is approved so that the account and the facial information of the presenter are associated. The presenter could also associate their digital identity envoy stored in their self sovereign wallet. When opening a credit account it is typical for the lending institution to conduct KYC and underwriting. The presenter could validate themselves and their financial, credit, and other relevant information to the approval process by using their immutable identity that was created through verification to a government source of truth with certainty rating. This self sovereign wallet is a zero trust biometric access storage medium and is then associated with their credit account. The account is opened (e.g., a card sent to the presenter) and the card can have the digital identity authentication instructions stored on it or the account number that can be used to retrieve the digital identity information. When the presenter then wishes to conduct a transaction, such as a purchase with a credit card, the presenter can interact with a transaction system. The presenter can have the facial information captured at the transaction location which can then be compared with the digital identity information and verified and authenticated. This can be in person or during online transactions ensuring that the credit card can only authorized and utilized with a biometric validation of the account holder. Additionally, other attributes of the digital identity, such as location and temporal references can be used for further validation and authorization purposes.

The digital information can be stored encrypted such as in hash format. The captured image can calculate the hash of the captured image and compare it with the stored hash. If these match, the presenting individual is verified without the need to expose the image or other information stored on the portable media. Hashing methods can include a-hash which is an average hashing and generally thought to be one of the simpler algorithms as it uses only a few transformations. This method generally scales the image, converts it to greyscale, calculates the mean and make the greyscale-based binary based upon the mean. The binary image is then converted into an integer. There can also be the p-hash method which is a perceptual hash that uses a discrete cosine transformation. There is also the d-hash method which uses gradients derived from the differences between adjacent pixels. There is also the w-hash method which uses wavelet transformations.

The digital identity record can be created according to the captured biometric information and the captured verification information associated with the individual. Therefore, a verified digital identity record can be created that can be subsequently authenticated. The system herein can be used to provide for a digital identity that can be used as or a substitute for a credit card, debit card, access card, identification, or other median where verification and authorization is desired.

Referring to FIG. 1A, a capture device 140 can be used to capture biometric information of a user who is seeking to have their identity verified and authenticated. The user can access a capture device 140 that can contain the digital envoy. The digital envoy can be stored or accessible by the capture device 140. The device can capture biometric information and present the biometric information and digital envoy to a transaction server 142. The transaction server can retrieve the digital identity record using the digital envoy and determine if the digital identity is authentic. If so, the transaction server can approve a transaction without the need for exposing personal information publicly. The digital envoy and the biometric information can be used which does not display personal information thereby improving the process of presenting identification documents such as drier licenses and passports.

In one embodiment, the holder of the digital envoy and digital identity information can select which information to provide to someone seeking authentication of the individual. For example, digital identity information can include name, facial image, driver's license number, birthday, address and other information. The presenter of the digital envoy can select which information to reveal or verify. For example, when being asked for identification from law enforcement in a traffic context, the presenter can elect to provide digital envoy and the driver's license number. In one example, when asked to provide proof of identification that may not be in a traffic situation, the presenter can elect to provide authentication of identification only. Therefore, the presenter can elect which information to present and which to withhold according to the identification authentication request. In one example, the presenter can elect to provide simply an AUTHENTIC or NOT AUTHENTIC status or return to the requesting entity without any further information being revealed. In this case, the digital envoy and biometric information is all that may be needed and presented to the identification requesting entity.

For example, if a buyer wishes to purchase a good from a seller, and the buyer wishes to authenticate the identification of the seller, the system can facilitate these authentications. The seller can present to the buyer a digital envoy and a biometric information which can be used to retrieve the digital identity record, determine if the biometric information matches the digital identity record and provide a response that the biometric information matches or does not match the digital identity record without having to expose the personal information of the buyer. The digital identity record, because it was created using the verification system, allows the buyer to authenticate the identity of the seller.

In one embodiment, the order in which the first record and the second record (e.g., validation, authentication, event, transaction, and the like) are written on the immutable storage can be used to show that some period of time elapsed between the first record and the second record. This functionality can be added to the verification and authentication process as attempts to improperly tamper with the immutable storage may be discovered when the first record and the second record are not in chronological order. This functionality can also apply to, include, and verify items, people, places, association, activities, events as well as confirm previous recording and storage of such information. For example, the system can capture user information, object information, event information and any combination such as capturing a digital representation of a physical object. The system can create a capture record representing the verified association of the digital representation with the physical individual, object, and event. The system can capture and record subsequent information about the object or event such as a subsequent transaction (e.g., in person authentication). A second capture record can be created and associated with the first capture record creating a history of individuals, objects, and events. When this information is captured and stored, attempts to improperly tamper with the immutable storage can be discovered when the metadata of the first record and the second record are inconsistent with the first record and the second record as stored. Each of these transactions can have a fee that can be used to determine the value of the transaction.

In one embodiment, metadata integrity used by the system can be designed to identify inconsistencies with date and time. For example, a capture sensor such as a camera, scanner or other input device can be used to capture one or more images from an individual. Any error or inconsistency in the metadata can be identified by comparing the metadata itself and the hash/block time of the metadata that was committed to the immutable storage system. The difference can be a discrete comparison or can be a determination that the information is within a range.

When the digital identity record is created, the record can include or be associated with biometric information of the individual. This information can be compared to the subsequent biometric information so that a positive comparison can result in the identity being validated and authenticated. If the subsequently captured biometric data does not match the digital identity record, the identity cannot be verified or authenticated during subsequent attempts. Therefore, a transaction can be ceased or the potential for mistaken or fraud can be identified. The individual presented an identity can be authenticated or can be denied.

The input into the capture device can include username and password. In one embodiment, the digital identity can be associated with digital storage such as a digital wallet. The identity and other information that is received can be used for authentication and verification of the identity of the user. The user can provide biometric information that can be compared to a local or remote database of identification information and the identity of the individual can be verified and authenticated. The object information can be captured and can include metadata related to the object including file types, creation dates, file attributes (e.g., format, compression, protocol, and the like), names, headings, and other data about the object and object information. The object information and the event information, along with its metadata can be compared metadata such as location and time to verify that the object information and the event information are authentic. The system can create a capture record which can be information about the capture of the object and event information and the capture record can be stored on the immutable storage system. Therefore, the capture record can be subsequently retrieved and compared with the original or subsequent object and event information for validation. The object information and the capture information can include a unique identifier associated with the object or event.

In one embodiment, the identity recording system can be used to capture biometric information of an individual. This information can be used to create the digital identity record which can be stored on the immutable storage system and associated with a digital envoy. The digital identity record can represent that certain individual biometric information was captured at a specific location, date, and time and to a certain surety level. The date and time can by temporal information that can be included or used to create the digital identity record. In one embodiment, the user of the identity recording system can have the user's information captured as well do that the digital identity record can include information concerning the creator of the record. When the identify record is captured the individual subject to the identify record can travel to another location. At the other locations, the individual can present the digital envoy and biometric information so that an authentication system can determine that the presenting individual of the digital envoy and the biometric information is the same individual as when the digital identity record was captured. This embodiment can be advantageous when facilitating immigration wherein the individual may not have a governmental issued identification. The system allows for a digital identity to be associated with the individual and which can be later authenticated to show that the same individual is identified.

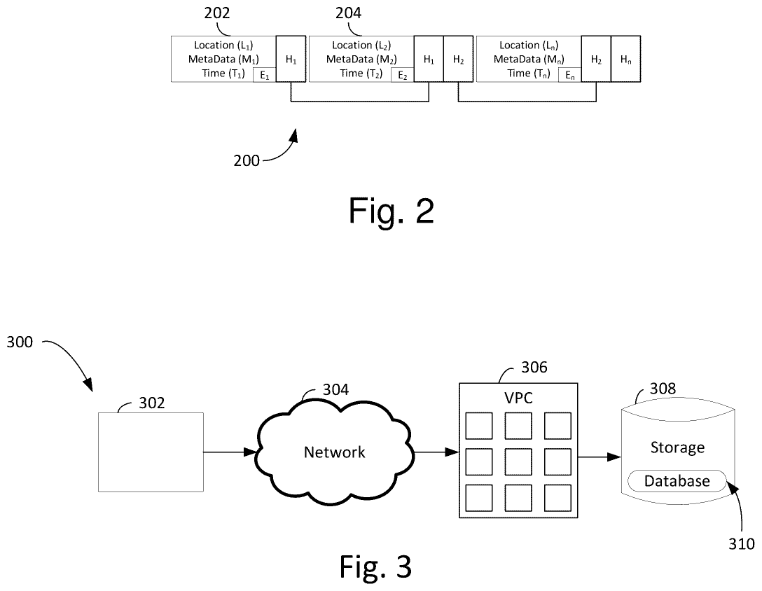

Referring to FIG. 2, in one embodiment the second event record 204 (e.g., identity verification) can be linked to the first event record 202 (e.g., digital identity creation) to create a digital audit trail 200 that includes indicia verifying that the individual remains the same individual throughout a process. A validation record can be created for the first event, the second event, the first plus second event and any combination including the inclusion of additional records. The system can also record changes in the event or object including changes in the locations, time, biometrics, thereby providing an audit trail of any changes.

The capture device can include biometric identification devices such as a camera or other capture devices that can capture facial recognition, voice recognition, retinal scans, fingerprint scanners, hand scanners, DNA, and other biometric information. In one embodiment, the capture device can include two-factor authentication prior to allowing the verification process to occur.

The system can also use smart contracts, self-effectuating or programmatic processes for business logic rules, where the verification of identification can be one of the criteria for implementing the smart contract for self-execution upon satisfaction and verification or the necessary individuals. For example, when an object is delivered from a seller to a buyer and the buyer validates the buyer's identity, a smart contact can instigate payment to the seller.

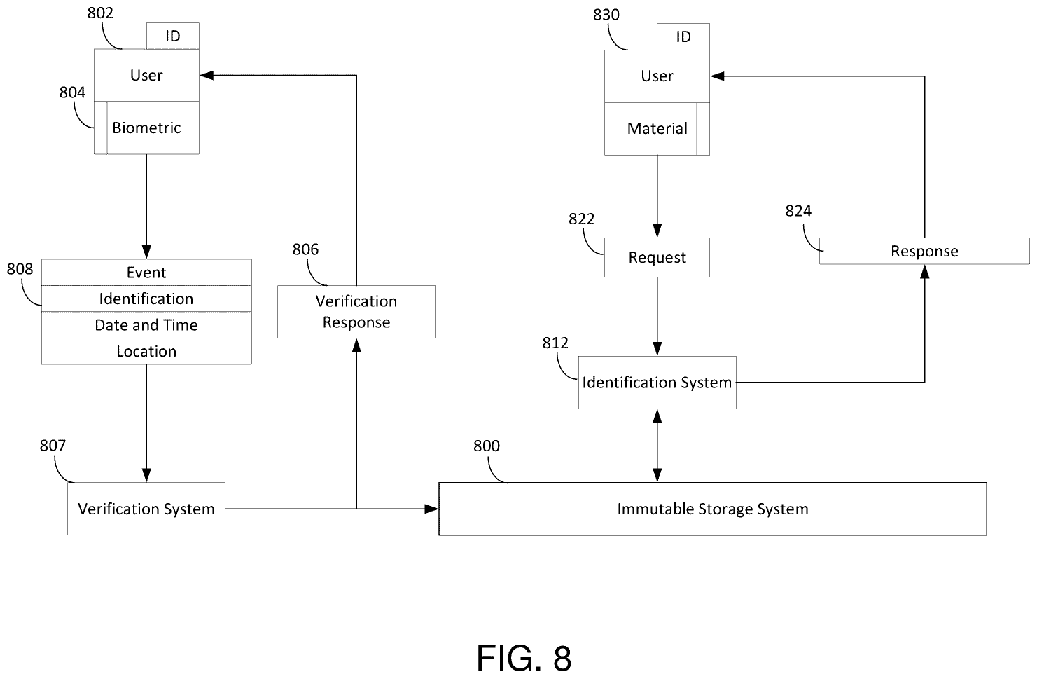

As shown in FIG. 3, the exemplary embodiments may be implemented in a decentralized computing environment 300, that may include distributed systems and cloud computing. FIG. 8 shows one or more systems 302 that may be in communication with a remote cluster 306 via network 304. System 302 can be identity recording systems, verifications system or transaction system and multiple of such systems can be in communication with an immutable storage system. Cluster 306 may store information received from system 302 and provide added computational functionality. The network may be a wired network or a wireless network or a combination thereof. The network 304 may be a secure internet connection extending between the system 302 and the cluster 306, such as a virtual private cloud (VPC). The server may be a computing device and can be in communication with the site computer device. Cluster 306 may include access to storage 308. Storage 308 may include database 810 in which information regarding a project location is stored in a consistent manner.

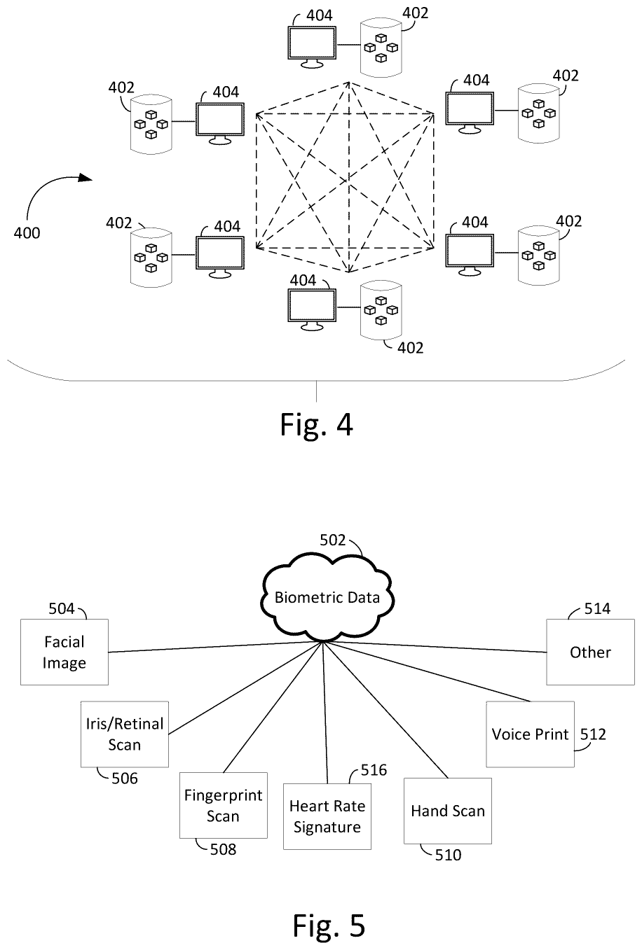

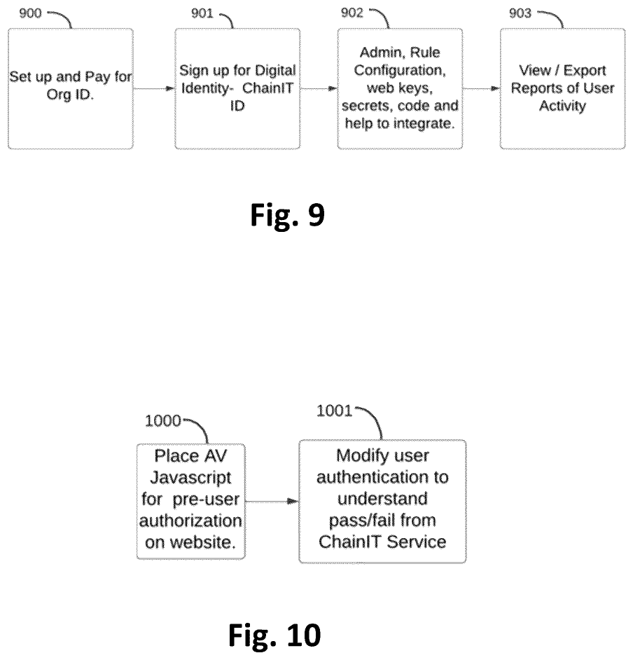

FIG. 4 shows diagram 400 of an example of a peer-based network where an immutable storage 402 is broadcast and shared among the nodes 404. A node can include a verification system and a transaction system. This network may be resident in the VPC cluster 806 (FIG. 8) or in a network for example. The nodes 404 may represent computing resources, such as server computer systems or other computing systems, residents at the parties identified in FIG. 9, for example. Each node that has access to a copy of the immutable storage system 402.

The various computer devices, including the server and site computer device (e.g., system, controller, and any combination), can be in communication with immutable storage system. The immutable storage system can include a distributed ledger, immutable database, block-chain structure, and the like. The communications between the various computer devices, including the server and the site computer device and immutable storage can be a global communications network, wide area network, or local area network, delivered to a computer readable medium from one device to another (e.g., USB drive, CD, DVD) and can be wired or wireless.

Referring to FIG. 5, biometric data 502 that may be obtained by biometric-based identification devices at the project location to attempt to identify individuals. Biometric data may include facial recognition 504, an iris/retinal scan 506, a fingerprint scan 508, a hand scan 510, a voice print 512 or heart rate signature 516 or other input or sensor 514. It should be noted that other types of biometric data may also be used in exemplary embodiments to help identify individuals uniquely. Also, an individual may be required to provide multiple types of biometric data in some instances.

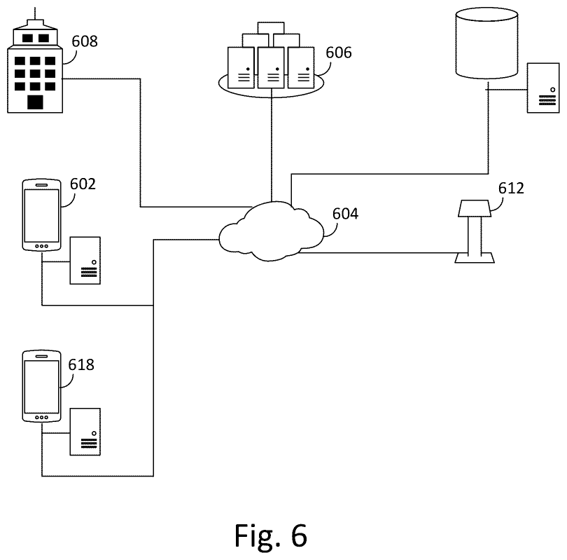

Referring to FIG. 6, computer device 602 can be in communications with a network 604 and immutable storage system 606. The capture device can be connected to a computer device or is in communication with the computer device or can be a computer device itself. The capture device can obtain information from other sources 608 such as third-party time and date information (e.g., atomic, and nuclear clock operators, weather information). The capture device 610 can be mobile 602 or stationary 612 so that the capture device can be placed near or at a user, object, or event location. Once user identification information, object information, event information, capture information is stored, another mobile computer device 614 or other computer device 616 can retrieve the stored information. The information can include an identifier that can be a physical identifier or digital identifier such as a QR code that can be affixed to the object or associated with an event. When the identifier is scanned, the various information and records can be retrieved. The system can include verification of an object and event with its digital representation with a subsequent computer device 618. In one embodiment, the digital identity can be created by device 602 as part of a verification process. Device 618 can be used as part of an authentication process.

Information that can be included in the verification system or used to query the verification can include event information, GPS data and addresses, times, attendees, and other object or process properties. The systems may store an object requirement record hash notification from the immutable storage, indicating that the hash value for the individual, object or event information has been referenced on the immutable storage. Information tracking the individual, object information or record may be stored in the database. A hash value resulting from passing information through a secure hash function can be stored, transferred and referenced on the immutable storage system.

To pair an individual with its digital representation the system can capture events at various points of an event, transition, or other activity. Pairing the physical with the digital representation can include several elements or components. Included in the pairing process can be the physical observation of the individual, an activity and then associate the physical with a digital representation so that the physical is properly associated with the digital representation. This verification provides trust that the digital representation is accurately associated with the physical as a factor rather than simply trusting that the digital representation is accurate. This system can use manual or automated processes to physically observe and associate the material with the digital representation during various events from raw material to final deliverables. Verification can also use the metadata that is associated with the interaction of physical items by individuals and electronics when the item is created, transported, installed, activated, and destroyed. The metadata that can be captured and placed into immutable storage can provide stakeholders with an audit trail of history for their physical asset using a verified paired digital representation. This process can be used for pairing a biometric identifier with an individual.

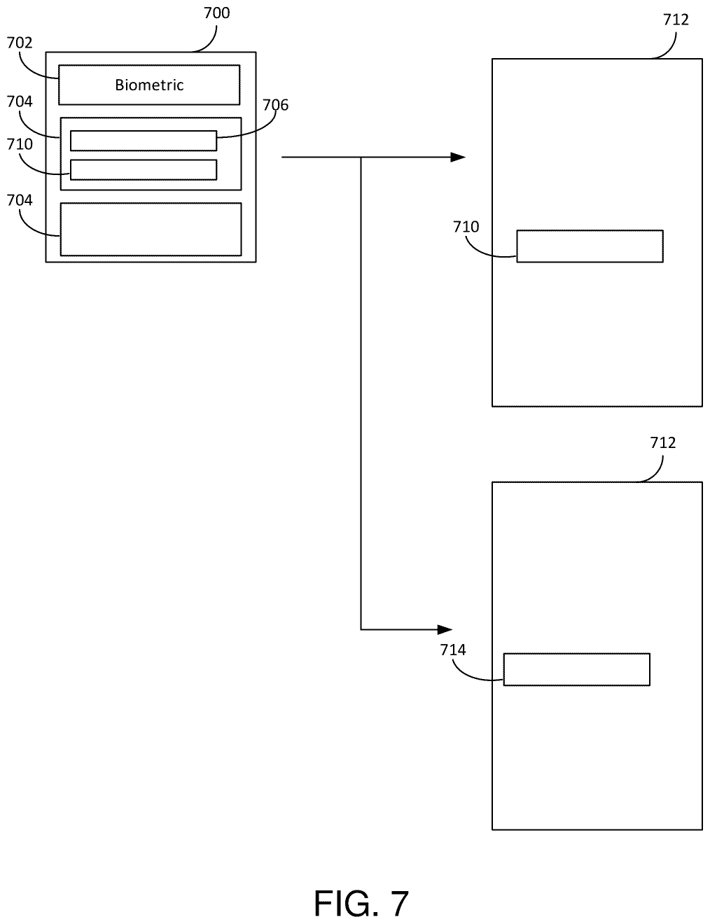

Referring to FIG. 7, when an individual wishes to present the digital envoy or biometric information for authentication, the user can select all or a portion of the information in or associated with the digital identity record. The presenting individual can select the information subset to be authenticated or revealed. For example, the presenting individual can select the name 710 of the individual to be revealed when the authentication system 712 retrieves the digital identity record. In another example the presenting individual can select the only authenticate the name of the individual without necessarily having the reveal the name itself. In this case, the authentication system can report a binary response 714 such as match and not matched.

In one embodiment, the verification system can determine a confidence score that is associated with the digital identity record. For example, if the verification system is a governmental system, the confidence score can be higher than if the verification system is self-authentication system. The authentication system can also report a confidence value with the authentication approval. For example, if the biometric image captured by the authentication system is a partial match to the biometric information in the digital identity record, the confidence value associated with the authentication system response can be lower than if the biometric image captured by the authentication system is a complete match. The confidence score can also be higher when additional attributes of digital identity creation match information in the government record. For example, if the digital identity is created at a location that is also referenced on the government record, then the certainty level will be higher than if the digital identity is created at a location other than what is identified on the government identification record. Additionally, multiple validations of the individual at a specific location through biometrics would generate an experience history of continual biometric validations over an extended period of time further increasing the certainty level.

A self-verification system can include an individual presenting biometric information and potentially other identifying information that can be used by the identity recording system to create the digital identity record and the digital envoy. In this case, the individual could present biometric information that can be used for the creation of the digital identity record. The individual can also present identification with biometric information. The identity recording system can use other information including metadata such as location, time, and date.

Referring to FIG. 8, a user 802 has biometric information 804 that can include information 808 that can be transmitted to a verification system 807. A verification response 806 can be provided back to the user. Another user information can make a verification request 822 that is sent to an identification system 812 resulted in a response 824 which can all be stored on the immutable ledger 800. The user capture device 830, can capture identity information such as biometric information and provide a digital representation (e.g., token) that can be used to send a request 822 to an identification system 812 that can result in the digital representation being retrieved from the immutable storage system. If the information sent to the identification system matches the information retrieved from multiple immutable storage systems, a response 824 can be sent that affirms that the identity presented is authentic. In one example, the user of the capture device captures the presenting individual's facial image. The presenting individual also provides a digital envoy that is associated with the presenting individual. The capture device or identification system retrieves the digital representation of the individual from the immutable storage system using the digital envoy (e.g., QR code, bar code, alpha numeric code and the like). The provided facial information is compared to the facial information of the digital representation and if a match occurs, the identity is authenticated.

The system can also facilitate the use of digital wallets or other digital storage technologies through zero trust, non-custodial, access based on the biometrics of the individual without a password. The information that is contained on the digital wallet can be paired with a physical object so that transactions associated with the physical object can be conducted with verification that the digital representation in the digital wallet represents the physical object, whether the physical object is fungible or unique.

The computer system can be in communication with an immutable storage; a first computer device in communications with the computer system; a second computer device in communications with the computer system; a set of computer readable instructions included in the computer system configured for: receiving an event record from the first computer device including a first location, a first time and a first set of metadata wherein the first set of metadata includes an original digital representation captured by the first computer device of the physical object, receiving a subsequent event record from the second computer device including a second location, a second time temporally subsequent to the first time and a second set of metadata wherein the second set of metadata includes a subsequent digital representation captured by the second computer device of the physical object, and, determining if the original digital representation is equivalent to the subsequent digital representation thereby providing for verification that the same physical object transitioned from an originating event to a subsequent event.

The event record can include a verification and authentication code that can be used to verify that the data in the event record remains accurate from its creation from another time. The verification can have several constructions including checksum. A checksum can be a small block of data, usually digital, derived from another block of digital data configured for use for detecting errors that can occur transmission, storage or unintentional or intentional tampering with the data. A first record can have a first checksum. A second record can have a second checksum. The second checksum can be derived from the first and the second record so that alteration of the first or second record can be detected with the second checksum.

Certain verifications and authentications can be a hash. A hash can be a mathematical function that is configured to converts an input, such as a data record, into an encrypted output, typically having a fixed length. Therefore, a unique hash can be the same size regardless of the size of amount of the input (e.g., data). Further, the hash can be configured to prevent reverse-engineering of the input because the hash functions is a one-way function. When analyzing a record, such as an event record, comparing a first hash that can be created and stored with the event record and a second hash calculated when the event record is retrieved can provide validation that the data is unaltered from storage to retrieval. The verification code can be the hash.

In one example, a data record is an input that is processed with computer readable instructions configured with a hashing algorithm that can include a secure hashing algorithm, message digest algorithm, Keccak, RACE integrity primitives' evaluation message digest, Whirlpool, BLAKE, and the like and any combination. The output can be a first verification code and that first verification code is stored on an immutable ledger or other secure location. The hashing algorithm can be deterministic so that the input will result in the same output. The hashing algorithm can be configured to prevent the ability to see or read the data that is the original input. The hashing algorithm can be configured so that a small change, even one byte, will change the output. Therefore, the first output of the data will not match the second output if the data is changed between when the first data and the second data is determined.

The set of computer readable instructions can include instructions for determining if a similarity between the original digital representation and the subsequent digital representation is within a predetermine range. The first computer device can be remote from the computer system. The subsequent event record can include verification data representing that verification of the physical object subject to the subsequent event is the same physical object associated with the originating event according to the first event record. The set of computer readable instructions can include storing the first event record on the immutable storage and the set of computer readable instructions for determining if the first digital representation is equivalent to the subsequent digital representation includes retrieving the first event record from the immutable storage. The subsequent event record can include verification data representing that an individual viewed the metadata of the first event record and compared it with the physical object. The second set of metadata is taken from sources from the group consisting of public records, enterprise software, computer devices or any combination thereof.

The set of computer readable instructions can include instructions for determining if the individual is the same individual represented by the first digital representation during an occurrence of a second event. The subsequent event record can include verification data representing that verification of the physical object subject to the subsequent event is the same physical object associated with the first event. The subsequent event record can include verification data representing that an individual viewed the metadata of the first event record and compared it with the physical object. The first computer device can be a remote from the computer system and the second computer device.

The computer readable instructions can include instruction for determining if the similarity is within a predetermine range. The computer readable instruction can include instructions for determining if a similarity between the first digital representation and the second digital representation exists includes retrieving the first event record from the immutable storage. The subsequent event record includes verification data representing that verification of the physical object subject to the subsequent event is the same physical object associated with the first event according to the first event record. The computer device can be the first computer device; and the computer readable instruction can include instructions for determining if a similarity between the first digital representation and the second digital representation exists includes retrieving a first image of the physical object, comparing the image to a second image captured by a second computer device and determining if the images represent the same physical object. The instructions can determine if a similarity between the first digital representation and the second digital representation exists includes capturing an object indicium affixed to the physical object, comparing the indicium on the object at the subsequent event to a digital indicium included in the first event record. The subsequent event record can include verification data representing that an individual viewed the object indicium and compared it with the digital indicium retrieved from the immutable storage and included in the first event record.

This system provides for creating and storing a unique digital identity associated with an individual and can include a verification system having a first capture device adapted to capture biometric information, alpha numeric information and graphical information to provide a digital representation of the individual; an identity recording system in communications with the first capture device and an immutable storage system; a portable media adapted to receive the digital representation; am authentication system adapted to receive a biometric information from a second capture device, retrieve the digital representation from the portable media, compare the biometric information with the digital representation and determine if the biometric information and the digital representation match.

The system can use a verification system taken from the group consisting of a government verification system, a witness verification system, an organization verification system, an aggregate of one or more events, a self-verification system, an in-person verification system and any combination thereof, wherein the authentication system is an autonomous computing system, the verification system is adapted to create a confident value associated with the digital representation, and the digital representation is a hash of biometric information.

The system can use account information representing an account associated with the individual; a verification system adapted to capture an individual information with aa first capture device and create a digital information representing the individual and associate the digital information with the account information; a portable media having account information; and a transaction system adapted to receive a presenter information from a second capture device, retrieve the digital representation, compare the presenter information with the digital representation and determine if the presenter information and the digital representation match. The digital information can be a hash of a facial information of a presenter. The second capture device can be a presenter mobile device, and the transaction system is adapted to receive presenter information from the presenter mobile device and transmit the presenter information to the transaction system.

The digital information can be stored on a portable media, on the immutable ledger or both in some embodiments. The portable media can be a card, personal computer, portable computer or mobile device. The digital information can be access with a pointer is stored on a portable media adapted to retrieve the digital information originating from the verification system. The system can include account information representing an account associated with the individual and associated with a digital information representing the individual; a portable media having account information; and, a transaction system adapted to receive a presenter information from a second capture device according to the presentation by the presenter of a portion of the account information, retrieve the digital information, compare the presenter information with the digital information and determine if the presenter information and the digital information match. The second capture device can be a presenter mobile device and the transaction system can be adapted to send a link to the presenter mobile device requesting that presenter information is captured and transmitting the presenter information to the transactional system.

The system allows for anonymous, selective attribute validation where users can verify attributes such as age or residency without disclosing personal data. Digital identities are stored in secure, decentralized storage and validated against authoritative sources such as government databases, financial institutions, and regulatory records. The system utilizes a digital envoy, a portable authentication token that enables identity validation across multiple digital platforms while maintaining privacy and security.

Unlike traditional identity systems that rely on centralized databases and are vulnerable to breaches, this system ensures that personal data remains under the control of the individual while still allowing third-party verification without exposing underlying identity attributes. The digital envoy improves privacy by limiting the exposure of identity attributes, reducing fraud risks, and preventing unauthorized tracking. The invention is applicable to financial transactions, online authentication, access control, and regulatory compliance, providing a universal, fraud-resistant, and privacy-preserving digital identity solution.

The decentralized trust model ensures that once verified, identity attributes are immutable and cryptographically secured, reducing reliance on centralized identity providers and minimizing exposure to identity fraud. By leveraging tamper-proof, decentralized storage and continuous biometric authentication, the system eliminates traditional password vulnerabilities and significantly reduces identity fraud and unauthorized access risks.

Referring to FIG. 9, the process begins at step 900, where an account is established, and the organization's identity is verified. This includes retrieving organization information from the Secretary of State, collecting Beneficial Ownership data, and tokenizing all related metadata onto the blockchain to create an immutable record of the organization's identity.

At step 901, the verified digital identities of individuals associated with the organization are established. This involves performing comprehensive checks, such as DMV verifications, sex offender registry reviews, and other relevant background screenings. The resulting digital identities are tokenized on the blockchain, ensuring secure, traceable, and tamper-proof records.

In step 902, once the organization and associated individuals have been verified and recorded on the platform, an authorized user can configure business rules to evaluate end-user access to website content. The system generates web keys, secrets, and integration code, enabling seamless communication between the website and the system.

At step 903, user activity is monitored and reported. This includes evaluating user interactions against the predefined business rules, ensuring compliance with organizational policies, and providing detailed activity reports for auditing and analysis.

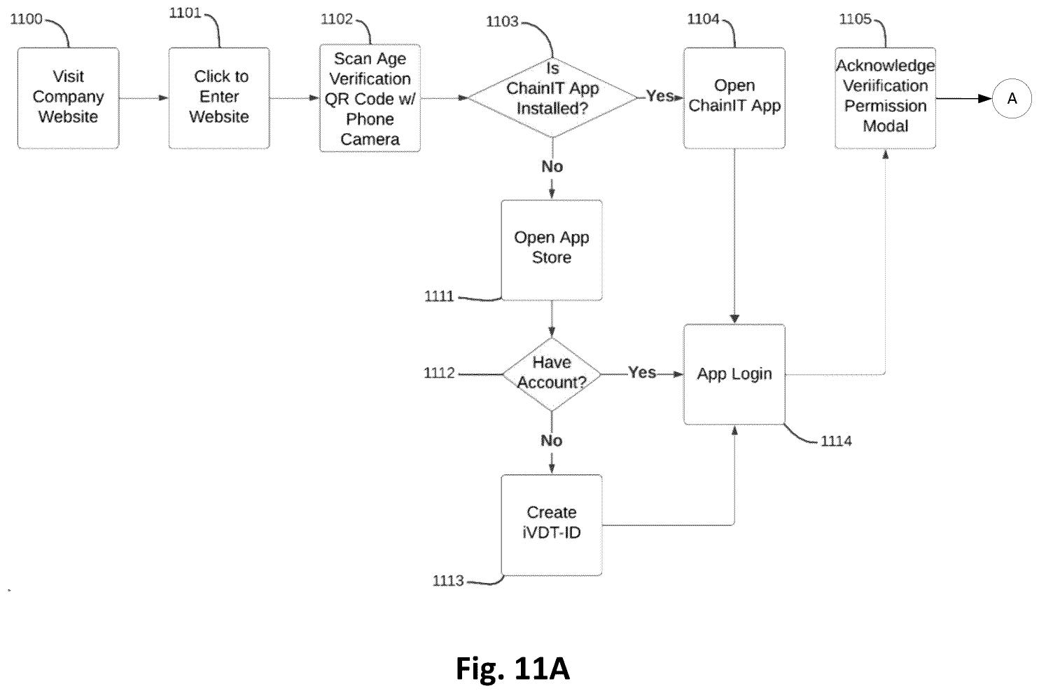

Referring to FIG. 10, the process of modifying user authentication workflows to incorporate pass/fail results from the system, ensuring secure and efficient user verification is shown. The workflow begins at step 1000, where the existing authentication system is modified to communicate with the platform. This modification enables the authentication system to send verification requests to the system whenever a user attempts to authenticate. At step 1001, the system processes the authentication request by performing a series of checks, including: identity validation for verifying the user's credentials against immutable records stored on the platform; biometric verification, confirming the user's identity using facial recognition, fingerprint scans, or other biometric data, if required; business rules compliance, evaluating the user against preconfigured business rules, such as location restrictions, account status, or age verification requirements; the system then returns a pass or fail result to the verification system. Pass occurs when the user passes the verification checks, and the authentication system then grants access to the requested resources or services. If the user fails the checks, the system denies access. Additionally, it may trigger follow-up actions, such as notifying the user of the failure or requesting further identity verification steps. This workflow ensures that user authentication processes are enhanced by leveraging the system's robust verification capabilities, providing advanced security, regulatory compliance, and real-time decision-making.

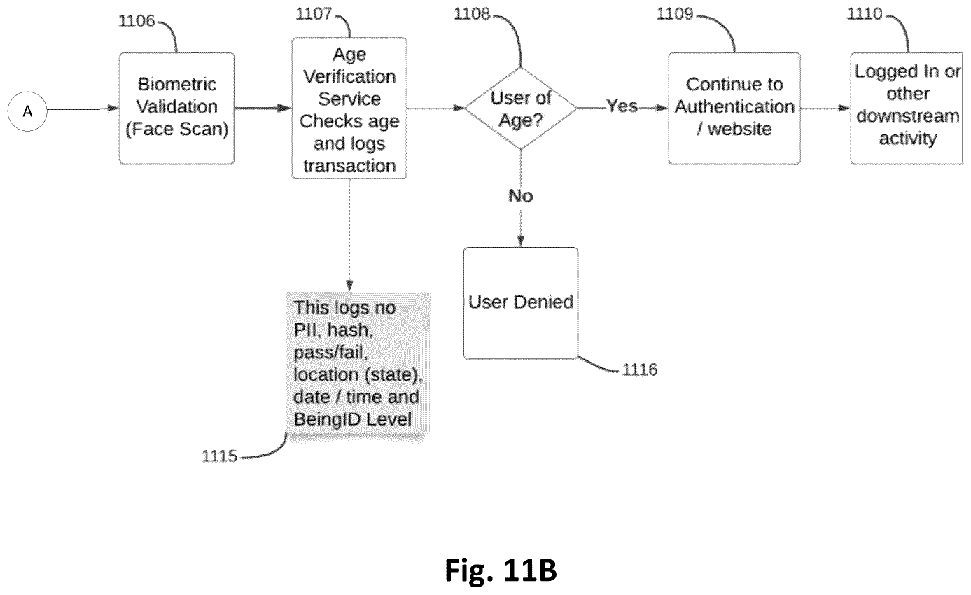

Referring to FIGS. 11A and 11B, an embodiment of a workflow for using the system to verify a patron's age for accessing an age-restricted website is shown. This process ensures compliance with state or federal age-restricted content laws. At step 1100, the patron navigates to an age-restricted website. Step 1101 displays a dynamic QR code on the website, which will be used to initiate the age verification process. In step 1102, the patron scans the QR code using their smartphone. Step 1103 determines whether the system application portion is installed on the patron's device. If the app is not installed, the workflow proceeds to step 1111, where the patron is directed to the appropriate app store (Apple App Store or Google Play Store) to download and install the app.

Step 1112 evaluates whether the patron has an existing account. If no account exists, step 1113 guides the patron through the process of creating an account and verifying their personal information with government agencies, such as the DMV. Once the account is established, or if the patron already has an account, step 1114 allows the patron to authenticate to the app using a biometric authentication mechanism.

If the app is installed, the workflow moves directly to step 1104. At this point, the patron is given the option in 1105 to share their personal information with the website based on the business rules configured by the business. Typically, this includes information such as current location, confirmation of being over the age threshold, and the account level. In step 1106, the system performs secondary biometric validation to ensure that the patron using the app is the same individual associated with the verified government data. Step 1107 evaluates the data shared by the patron against the website's predefined business rules. In step 1115, the data is immutably logged as a token on the blockchain, ensuring transparency and a tamper-proof record of the interaction. Step 1108 refers to the evaluation of the business rules configured by the website based on the patron's digital identity. If the patron does not meet the business rules, step 1116 enforces the restrictions, denying access to the website. If the patron successfully meets all business rules, step 1109 displays a successful outcome to the patron. In step 1110, the patron is granted access to the age-restricted content on the website.

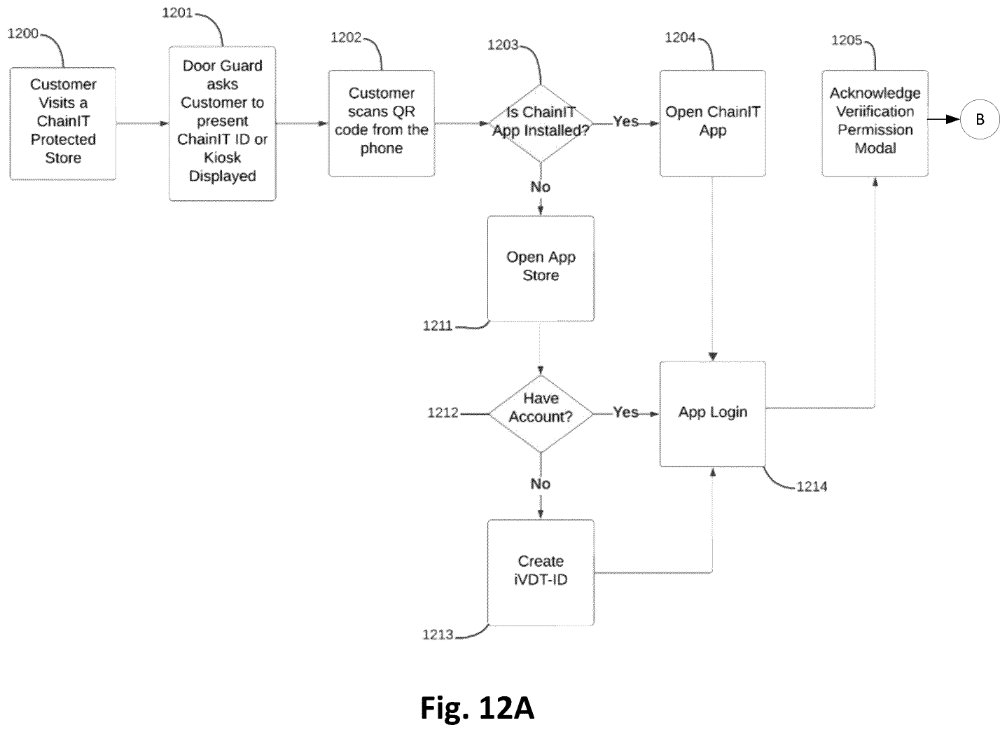

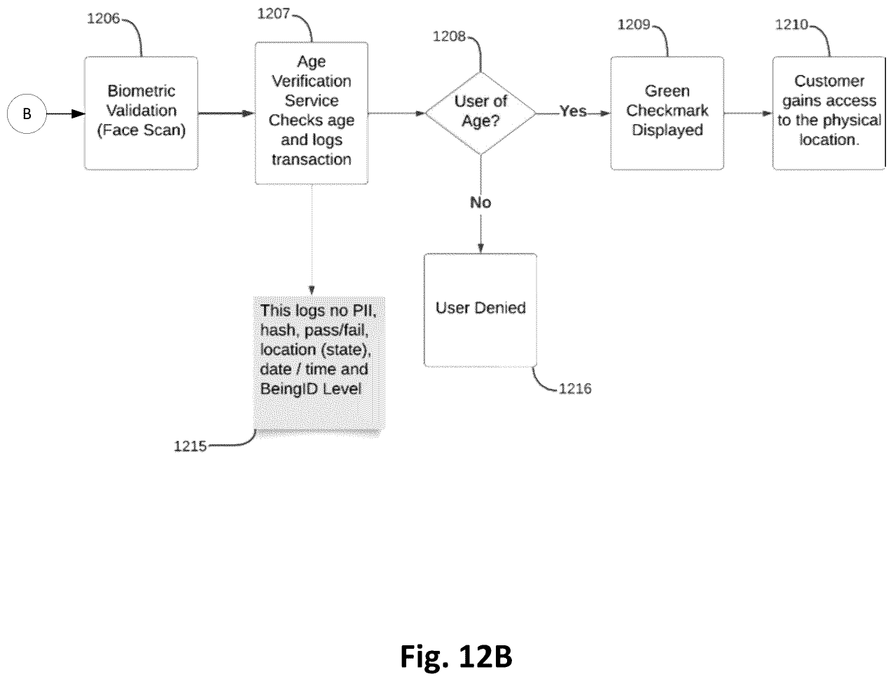

Referring to FIG. 12, the workflow for age verification when a business utilizes the system at a brick-and-mortar location, such as an age-restricted bar or age requirement is shown. In one embodiment, at step 1200, the patron approaches the location. In step 1201, the patron encounters a kiosk displaying a dynamic QR code intended for age verification purposes. In step 1202, the patron scans the QR code using their smartphone. The system then evaluates in step 1203 whether the system application is installed on the patron's device. If the application is not installed, step 1211 directs the patron to the appropriate “app store” (e.g., Apple App Store or Google Play Store) to download and install the app. Step 1212 determines if the patron already has an established account. If not, step 1213 initiates the account creation process, including verifying the patron's information with government agencies such as the DMV. Step 1214 indicates that, once onboarding is complete, or if the patron already has an account, they authenticate into the app using their biometric authentication mechanism.

If the app is installed, the workflow proceeds directly to step 1204. In step 1205, the patron is presented with the option to selectively share their personal information with the business, based on its configured business rules. Typical shared data includes the patron's current location, confirmation of meeting the age restriction threshold, and account surety level (e.g., confidence in the verification or authorization). Step 1206 performs a second biometric validation to confirm that the patron using the app is the same individual associated with the verified government data. In step 1207, the system evaluates the shared data against the business's predefined rules. Step 1215 logs the evaluation data immutably as a token on the blockchain, ensuring transparency and tamper-proof record-keeping. Step 1208 refers to the evaluation of business rules configured by the business based on the patron's digital identity. If the patron does not meet the requirements, step 1216 applies the configured restrictions, denying access. If all business rules are successfully met, step 1209 displays the successful outcome to the patron. Finally, in step 1210, the patron is granted access to the location.

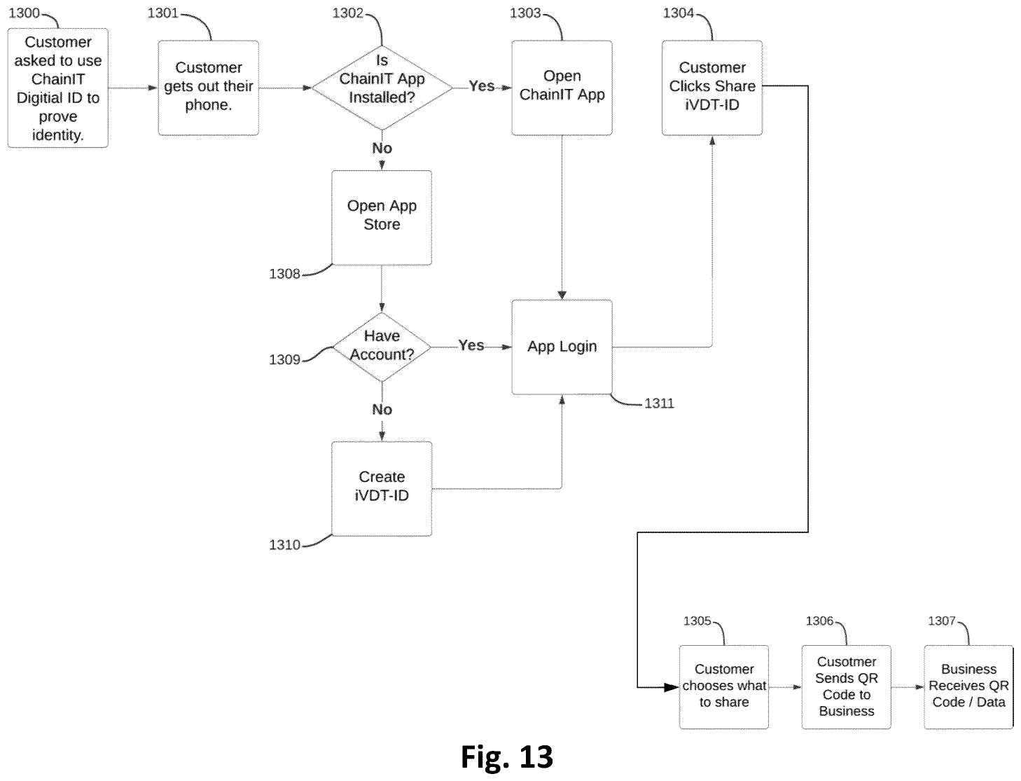

Referring to FIG. 13, the outline the workflow for a customer to share their digital envoy or digital representation with a business to verify their identity is shown. The process can begin at 1300, where the customer is asked to use their digital information for identity verification, such as confirming their age or verifying credentials. In one embodiment, at 1301, the customer retrieves their smartphone to initiate the process. Step 1302 evaluates whether the system application (i.e., app) is installed on the device. If the app is already installed, the workflow proceeds to 1303, where the customer opens the app. In 1304, the customer selects the option to share their digital envoy or digital representation thereby initiating the identity-sharing process. At 1305, the customer is presented with the ability to choose which specific attributes or information to share with the business, such as name, age, or location, depending on the business's requirements. The customer can share one, some or all of the attributes or information. Once selected, at 1306, the app can generate a secure QR code or other identifier containing the chosen data, which the customer then sends or presents to the business. At 1307, the business receives and processes the shared data or QR code for verification.

If the app is not installed, the workflow directs the customer to 1308, where they are taken to the appropriate “app store” (Apple App Store or Google Play Store) to download and install the app. Once the app is installed, step 1309 determines whether the customer has an existing account. If the customer does not have an account, the process moves to 1310, where the customer creates an account and establishes their identification by verifying their identity with trusted sources, such as government agencies. If the customer already has an account, the workflow continues to 1311, where they log into the app using their credentials and proceed to share their identity with the business as described above.

This workflow ensures a seamless, secure process for businesses to verify customer identities while allowing customers to maintain control over what information they share.

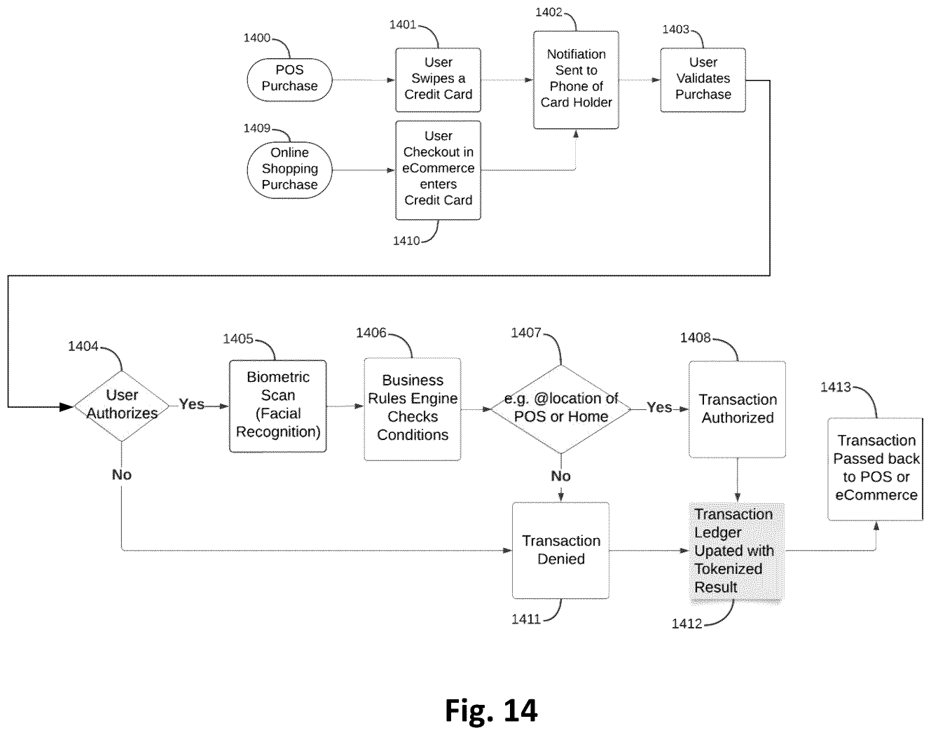

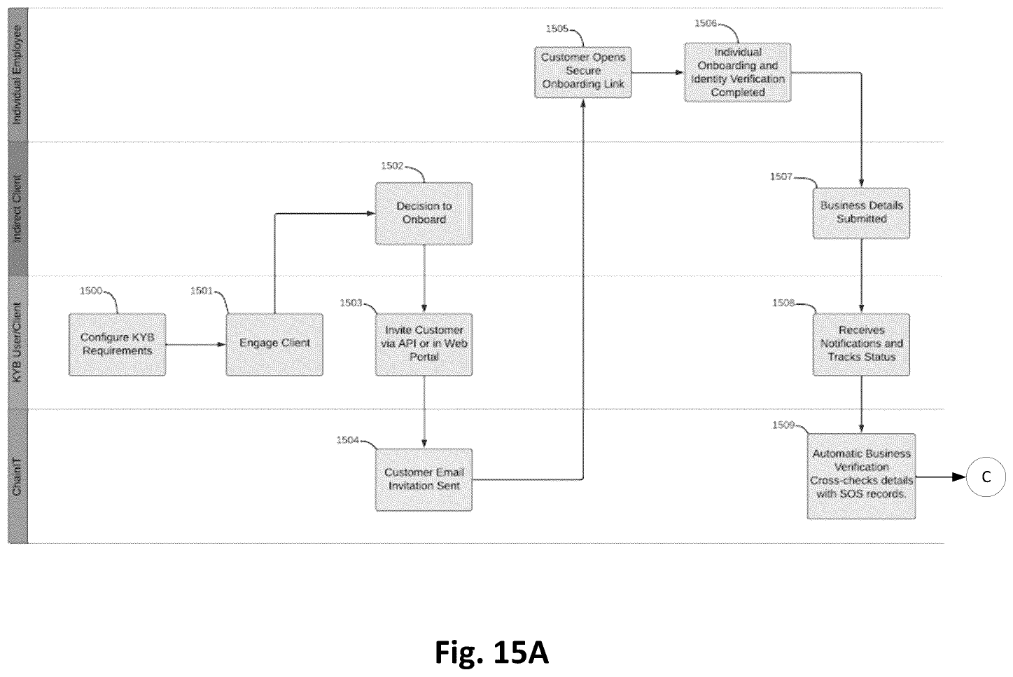

Referring to FIG. 14, one embodiment of the workflow for transaction authorization, applicable to both point-of-sale (POS) purchases and online shopping scenarios is shown. The system can integrate biometric validation, real-time notifications, and a business rules engine to ensure secure and compliant transaction processing. Step 1400 is shows the process when a user initiates a transaction by swiping their credit card at a POS terminal. Step 1401 shows the system capturing the credit card details and triggering a notification to the registered phone of the cardholder. Step 1402 shows a notification is sent to the cardholder's phone, informing them of the transaction. Step 1403 shows the user validating the purchase by interacting with the notification on their phone. Step 1404 shown the user authorizing the transaction by confirming their intent to proceed. Step 1405 shown the system performing a biometric scan (e.g., facial recognition) to verify the identity of the cardholder.

The system can also be used for eCommerce. In one embodiment, step 1409 shown the process of the user making an online shopping purchase by entering their credit card information during checkout. Step 1410 shows the credit card details being submitted, and the workflow can proceed to validation and authorization steps similar to the POS workflow.

The system can also include shared Workflow for POS and eCommerce. In this embodiment, step 1406 shows a business rules engine that can evaluate the transaction against predefined conditions, such as spending limits, location, or merchant restrictions. Step 1407 shown business decision rules that can determine whether the transaction should be authorized or denied. Step 1411 shows that if the transaction violates the business rules, it is denied. Step 1412 shows that regardless of the outcome, the transaction ledger is updated with a tokenized result, ensuring an immutable record of the transaction is created and stored. Step 1408 shows that if all conditions are met, the transaction is authorized. Step 1413 shows that the authorization or denial is passed back to the POS terminal or eCommerce platform, thereby completing the transaction workflow.

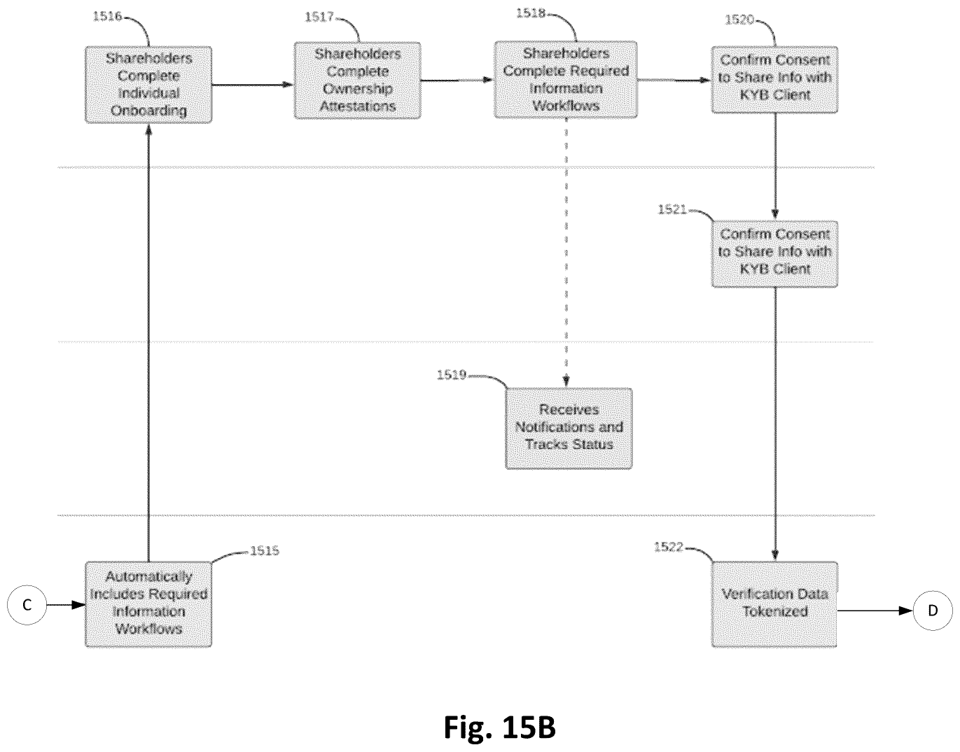

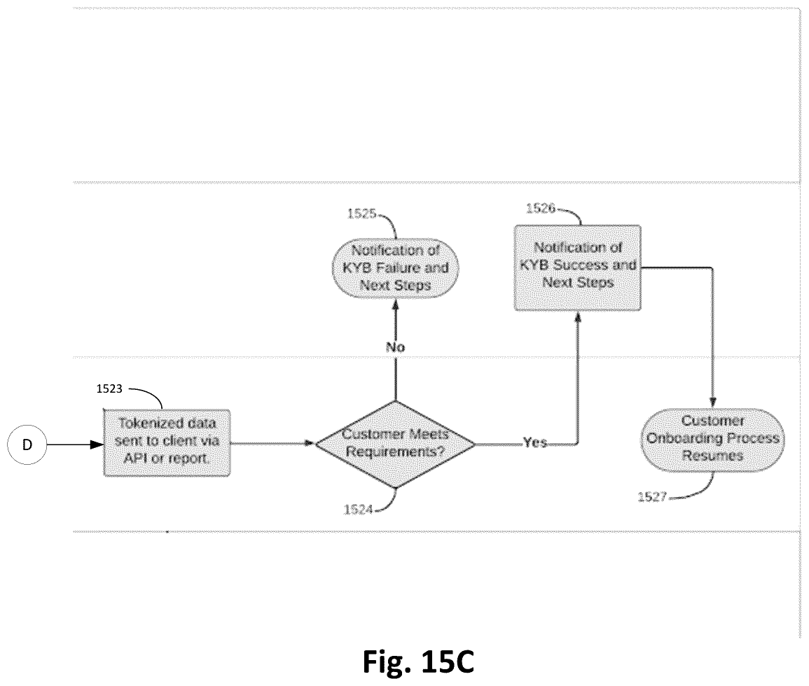

Referring to FIG. 15, one embodiment of the workflow for onboarding businesses using the systems and the KYB (Know Your Business) schema is shown. The process can begin with the configuration of KYB requirements at 1500, where the platform is tailored to meet the client's specific compliance needs. At 1501, a business client is engaged, and at 1502, a decision is made on whether to proceed with onboarding. Once approved, the client is invited to the onboarding process through an API integration or via the system web portal, as shown in 1503. A secure email invitation can be sent to the client at 1504, providing access to the onboarding process. The client clicks the secure link in the email to initiate their onboarding at 1505. The workflow continues with individual identity verification at 1506, ensuring the individuals representing the business are validated. At 1507, the client submits business details, including ownership structure and required documentation. Notifications are sent to the client, allowing them to monitor the onboarding status through the platform at 1508.

In one embodiment, at 1509, the system performs an automatic business verification, cross-checking the submitted details against Secretary of State (SOS) records to confirm the legitimacy of the business. Upon successful verification, an administration account is created at 1510, and the client logs into the system portal at 1511 to continue the process. In one embodiment, the Ultimate Beneficial Ownership (UBO) workflow can begin at 1512, where the client enters ownership details and uploads the necessary documentation. Notifications are sent at 1513 to track the status of the workflow, and at 1514, the system automatically invites required shareholders to participate in the process. In 1515, the platform includes all required compliance workflows for shareholders to ensure full regulatory coverage. At 1516, shareholders complete their individual onboarding and identity verification. Shareholders provide ownership attestations at 1517 and complete additional required compliance workflows at 1518. Throughout this phase, stakeholders receive real-time notifications and status updates, as represented in 1519.

Once the onboarding process is complete, consent is obtained to share the verified information. At 1520, the client confirms their consent, and at 1521, shareholders provide their consent as well. At 1522, the verification data is tokenized, ensuring it is immutable and securely stored on the blockchain. The tokenized data is then sent to the KYB client via API or as part of a comprehensive report, as shown in 1523.

The system evaluates whether the client meets KYB requirements at 1524. If the client fails the process, the platform notifies them of the failure and provides next steps at 1525. If the client successfully meets the requirements, the platform sends a notification confirming the KYB success and outlines next steps at 1526. Finally, at 1527, the client's onboarding process resumes, allowing for full integration into the system.

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example, and the invention may be practiced according to the claims without some or all of these specific details. For the purpose of clarity, technical material that is known in the technical fields related to the invention has not been described in detail so that the invention is not unnecessarily obscured.

What is claimed is:

1. A digital system for management of a digital identity associated with an individual comprising:
a capture device wherein the capture device is adapted to capture a biometric information, an alphanumeric information, a graphical information and any combination;
a verification system in communications with the capture device; and
wherein the verification system is adapted to create a digital representation of the individual according to the biometric information, receive a digital envoy creation request, transmit the digital representation to an authority system; create a digital envoy uniquely associated with the digital representation according to receiving creation authorization from the authority system, and store the digital envoy on a portable media.

2. The digital system of claim 1 wherein the capture device is a first capture device and the verification system is adapted to receive the biometric information from a second capture device, retrieve the digital envoy from the portable media, compare the biometric information with the digital envoy, and generate a verification information representing a match between the biometric information with the digital envoy.

3. The digital system of claim 1 wherein the digital envoy is compliant with a regulatory privacy requirement.

4. The digital system of claim 3 wherein the regulatory privacy requirement is taken from the group consisting of General Data Protection Regulation, California Consumer Privacy Act, Know Your Customer, anti-money laundering regulations, Children's Online Privacy Protection Act, decentralized identity standards under W3C, and any combination thereof.

5. The digital system of claim 1 wherein the verification system includes a fraud prevention module taking from the group consisting of adaptive liveness detection, deepfake resistance technology, continuous biometric monitoring, behavioral authentication, and any combination thereof.

6. The digital system of claim 1 wherein the authority system is a governmental entity recordation system adapted to provide the creation authorization upon a successful comparison of the digital representation with a governmental entity identity dataset.

7. The digital system of claim 1 wherein the verification system is adapted to store the digital envoy on an immutable ledger.

8. The digital system of claim 1 wherein the authority system includes a multi-tiered framework having government, enterprise, and decentralized identity providers.

9. The digital system of claim 8 wherein the authority system is adapted for real-time fraud detection using machine learning based anomaly detection.

10. The digital system of claim 1 wherein the verification system creates a digital envoy according to a smart contract-based identity validation.

11. The digital system of claim 1 wherein the verification system creates a digital envoy according to a geofenced authentication validation.

12. The digital system of claim 1 wherein the verification system is adapted to identify and store relationships between an individual digital identity and an organizational identity.

13. The digital system of claim 1 wherein the digital envoy is adapted to verify financial transaction identity validation in real time using biometric confirmation.

14. The digital system of claim 1 wherein the verification system is adapted to receive an interrogation biometric input representing an identity interrogation, retrieve the digital envoy, compare the digital representation with the interrogation biometric input, and determine a match between the digital representation with the interrogation biometric input without disclosing personal identifying information.

15. The digital system of claim 1 wherein the verification system includes a fallback authentication process that includes a process selected from the group consisting of a one-time cryptographic challenge, a secondary multi-modal biometric confirmation, an adaptive risk-based verification, a hardware-token authentication, and an out-of-band identity verification.

16. The digital system of claim 1 wherein the verification system includes logs for auditing and regulatory oversight stored on an immutable ledger.

17. A digital system for management of a digital identity associated with an individual comprising:
a verification system adapted for receiving biometric information of the individual captured by a capture device, creating a digital representation of the individual based on the received biometric information, transmitting the digital representation to an authority system, creating a digital envoy uniquely associated with the digital representation upon receiving creation authorization from the authority system, storing the digital envoy on an immutable ledger; and,
wherein the verification system is adapted for receiving subsequent biometric information for authentication, retrieving the digital envoy from the immutable ledger, comparing the subsequent biometric information with the digital representation associated with the digital envoy; and generating a verification result based of the comparison.

18. The digital system of claim 17 wherein the digital envoy is stored in a non-custodial digital wallet.

19. The digital system of claim 18 wherein the digital envoy can only be accessed after providing and verification of the biometric information.

20. The digital system of claim 17 wherein the digital envoy is stored in a self-sovereign storage media.

21. The digital system of claim 20 wherein the digital envoy can only be accessed after providing and verification of the biometric information.

22. A digital system for management of a digital identity associated with an individual comprising:
a verification system adapted for creating a digital representation of the individual based on biometric information, transmitting the digital representation to an authority system, creating a digital envoy uniquely associated with the individual upon receiving creation authorization from the authority system, storing the digital envoy on an immutable ledger; and,
wherein the verification system is adapted for receiving subsequent biometric information, retrieving the digital envoy from the immutable ledger, comparing the subsequent biometric information with the digital representation associated with the digital envoy; and generating a verification result based on the comparison.

23. The digital system of claim 22 wherein generating the verification result prevents disclosure of personal identifying information associated with the individual.

24. The digital system of claim 22 wherein generating the verification result includes providing a portion of personal identifying information associated with the individual.
